(19) United States
(12) Patent Application Publication
(10) Pub. No.: US 2001/0025255 A1
(43) Pub. Date: Sep. 27, 2001

(54) Internet multi-media exchange

(76) Inventor: Robert E. Gaudian, Fairfax Station, VA (US)

Correspondence Address: Thomas P. Liniak, Esq., Liniak, Berenato, Longacre & White, LLC, Suite 240, 6550 Rock Spring Drive, Bethesda, MD, 20817, US

(21) Appl. No.: 09/734,765

(22) Filed: Dec. 13, 2000

Related U.S. Application Data
(60) Provisional application No. 60/170,581, filed on Dec. 13, 1999.

(51) Int. Cl. G06F 17/00

(52) U.S. Cl. 705/26

(57) ABSTRACT

A system providing for worldwide syndication and distribution of multi-media content on the Internet and providing a single online marketplace for the purchase and sale of news, entertainment features, educational and training programs, archival footage, talent demos and other digital content. A user's web page is able to link to a selected list of digital data items without the need to upgrade the user's computer to handle to storage and transmission of voluminous data because the data is accessed via a separate stand-alone web site and the user is unaware that he/she has left the user's web site. The host's Internet-based network solutions enable content providers to offer the reuse of their content on both a cash and/or barter basis. The customized systems feature content from the affiliate organization or other content providers, Internet functionality, storage and bandwidth. In return, the host receives fees and/or a percentage of the advertising revenue and/or commission on cash sales.

### BACKGROUND OF THE INVENTION

1. Field of the Invention

The present invention relates to providing digital content to users over the Internet without the need to develop and manage the technology, bandwidth, storage and content relationships on a per Internet site basis.

2. Description of Related Art

The expansion of the Internet and the convergence of the world's communications technologies are increasing demand for information and entertainment content. Whether it's the television commercial we are watching, the corporate brochure we are reading or the radio news program we are listening to, we are experiencing the use of content. Video, audio, photos and text are used every day by the media, as well as by travel agencies, corporations, churches, advertising agencies, educators, governments and associations, to name just a few.

This growth in demand presents an opportunity for those who produce video, audio, photos and other forms of digital content to maximize revenue by making it more accessible and controlling its copyright. However, delivery of digital information has significant costs associated with developing and managing the technology, bandwidth, storage and content relationships on a per site basis.

Current web sites and digital content sources fail to provide a single online marketplace for the purchase and sale of news, entertainment features, educational and training programs, archival footage, talent demos and other digital content.

### SUMMARY OF THE INVENTION

The instant invention engages in the worldwide syndication and distribution of multi-media content on the Internet and provides a single online marketplace for the purchase and sale of news, entertainment features, educational and training programs, archival footage, talent demos and other digital content.

The inventor has developed software designed for the ingestion, sale and distribution of video, audio, photos and text on the Internet using electronic commerce (“e-commerce”). The rights to use copyrighted content (video, audio, photo and text) can be sold many times to media, business, education and consumers for use in a myriad of products and services. The host's Internet-based network solutions enable content providers to offer the reuse of their content on both a cash and/or barter basis. The customized systems feature high quality name-brand content, Internet functionality, storage and bandwidth. In return, the host receives a monthly fee plus a percentage of the advertising revenue.

The system also offers content providers the ability to ingest video, audio, photos and text content and corresponding metadata tags into custom branded sites via the Internet. The ingestor, called the Express, is password protected and offers each branded site the opportunity to authorize specific content providers and allow them to upload digital content files along with the associated metadata tags into their respective sites. The content is then searchable and displayed immediately on the Internet and available for preview, distribution and licensing using e-commerce.

These and other advantages provided by the present invention will become apparent when viewed in light of the following description and associated drawings.

### BRIEF DESCRIPTION OF THE DRAWINGS

FIG. 1 is a block diagram showing the interaction of the content providers, to the custom exchange or warehouse and the interface of the users on individual web sites with the warehouse through the ConnectCast platform.

FIG. 2 is a flow chart showing how the MediaStore and ConnectCast systems may interface for content ingestion.

### DETAILED DESCRIPTION OF PREFERRED EMBODIMENTS

Reference will now be made in detail to the preferred embodiments of the invention, examples of which are illustrated in the accompanying drawings. While the invention will be described in conjunction with the preferred embodiments and examples, it will be understood that they are not intended to limit the invention to these embodiments and examples. On the contrary, the invention is intended to cover alternatives, modifications and equivalents, which may be included within the spirit and scope of the invention as defined by the appended claims.

The present invention provides a data collection and warehousing system for digital information and an interface for users through any number of web sites, whereby the web sites interface with the warehouse without the need to download the digital information onto the web page. The system of this invention operates with a computer such as a personal computer using, for example, a Windows, DOS, UNIX or any other operating system running application programs or an operating system with remote access (i.e., Internet access) and capabilities. It should be noted that the term Internet is intended to encompass similar system and nomenclature (i.e., world wide web or .www) comprising the capability to communicate and access information through a network, telephone connections, ISDN connections, DSL connections, cable modem, fiber optic network etc. The present invention should not be limited in its communication nomenclature; the present invention is applicable to any system that is accessible by means of a global computer network.

The networks or “private exchanges” consist of two platforms. The first, called the custom “Exchange,” serves as the network hub or warehouse by aggregating content for reuse by authorized web sites. Authorized web sites serve as the web network's affiliates and are given access to a customized display platform called “ConnectCast” for distribution of the content. A more detailed description of these systems follows.

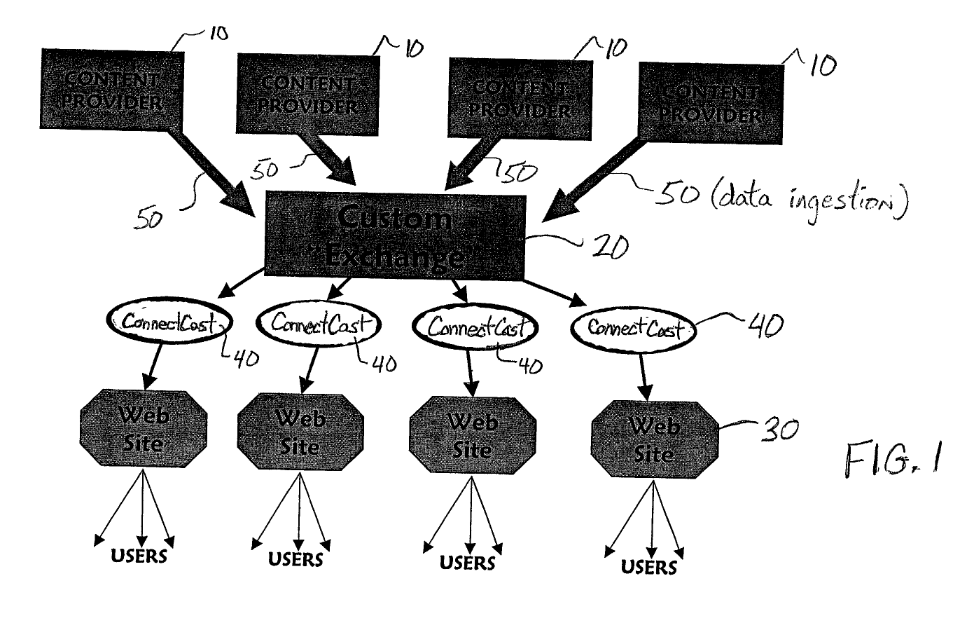

As shown in FIG. 1, the digital data is delivered from the content providers 10 to the custom exchange 20 (the “Exchange”) via an data system 50 described in more detail below, which forms the warehouse of information accessible in this system. Web site operators may then select relevant digital data for use on a specific web site 30 from the central exchange 20. More specifically, web site operators may agree to use selected materials from the custom exchange, and the selected materials are then accessible by the web site through the ConnectCast interface 40. For example, the web site operator may wish to provide digital data on a specific topic (e.g., great moments in sports) on the web site 30. The web operator would then reach an agreement with the host to use the digital data stored in the custom Exchange related to that topic. Access to the digital data related to that topic will then be specifically designated at the web site 30. When a user of the web site 30 wishes to view a video or listen to a radio broadcast for the topic (e.g., great moments in sports), they would view a list of specific choices (provided by the operator from the warehouse/custom Exchange) provided on web site 30 and they would have the ability to view or listen to any choice presented. While doing so, the web site user will never realize or know that they have been transported from the web site 30 to the ConnectCast interface 40 where they will access the digital data chosen by the web operator from the warehouse of information located in the custom Exchange 20.

The ingestor (see link 50 of FIG. 1), called the Express, is password protected and offers each branded site the opportunity to authorize specific content providers and allow them to upload digital content files along with the associated metadata tags into their respective sites. The content is then searchable and displayed immediately at the custom Exchange 20 and available for preview, distribution and licensing using e-commerce.

In the manner provided by this invention, the web site operator has the ability to offer a massive digital library from the web site 30 without the need to provide the storage and download capabilities typically necessary to transmit voluminous digital data.

The Exchange 20 offers affiliate organizations the opportunity to build their own branded Internet networks featuring their own content or content produced by other select operators or producers. This content defines the digital information. The host offers this turnkey solution in conjunction with the affiliate organization's web site 30 for a monthly fee which is significantly less than the cost of developing and managing the technology, bandwidth, storage and content relationships on a per-site basis.

The Exchange 20 is designed to link to the affiliate's web site 30 and provide seamless user functionality, including content search, previews, e-commerce and distribution. The site is branded to the affiliate web site so that users will not realize they have left the affiliate's web site 30 and entered the Exchange site 20 through the ConnectCast interface 40 managed by the host.

Through the Exchange platform users can aggregate, license and distribute two types of content: content that is available for purchase and content that is available on a barter basis to ConnectCast users.

Credit card buyers entering a customized Exchange 20 can search, preview and license current and archival video, audio, photos and text products on-line. The host receives a percentage of each order as compensation.

The Exchange 20 is also designed to allow preview and delivery of content items directly to the playlist of affiliated web sites using the ConnectCast system. Content may be offered via ConnectCast on either an e-commerce or barter basis in exchange for advertising revenues. The host is paid a percentage of site advertising sales received in conjunction with viewing the content.

ConnectCast is a showcase for the distribution of multimedia content to Web sites. ConnectCast is designed to take the hassle and expense out of developing and managing a video and audio enabled web site while still maintaining and building strong online brand recognition for participating affiliate organizations. Each ConnectCast is designed to display rich video and audio content produced either by the host organization or other leading producers to keep the site entertaining and highly functional. ConnectCast users have the option of viewing pre-programmed selections, video on-demand, and live events.

The host is responsible for providing the custom graphical interface, content streaming, digital encoding (optional), content storage, bandwidth, content aggregation and ongoing support and development. Until the introduction of the ConnectCast concept of this invention, few web sites have featured a significant offering of multimedia video and audio content on-demand. Many organizations have invested heavily in the Internet in the past and realize the high costs of developing and maintaining a multimedia-enabled site. These organizations understand that the potential revenue for the most successful sites seldom covers the costs. This need for high-end web functionality without the risk of substantial investment gives the host the opportunity to provide a custom solution for this market while spreading the costs across a broad user base.

The ConnectCast system involves two types of organizations: 1) the content provider, which serves as the content source and the host's customer, and 2) the affiliate organizations, which use the ConnectCast platforms and the associated content. To participate in the ConnectCast program, affiliate organizations are expected to promote their web sites to their client base. Affiliate web sites link seamlessly to a custom branded or co-branded (with host organization) ConnectCast platform. The platform is designed using contemporary graphics along with the affiliate's logo (and host's logo in co-branded sites) to give it a customized look and feel. Organizations that operate the Exchange 20 may also elect to charge affiliates a monthly fee to participate in their ConnectCast Web network. In this way, the users never realize that they leave the initial affiliate's web page and go to the ConnectCast web page to view the digital information.

Affiliate web sites benefit in several ways: They enhance the value of their sites to their online users, which will keep them coming back. This generates site traffic, which drives up the value and revenue from the sale of advertising on their respective Web sites, especially from ads located adjacent to the ConnectCast link. Users may also have the opportunity to purchase exclusive products from the affiliate web site or ConnectCast, which earns the affiliate additional revenues.

ConnectCast serves as a win-win opportunity for all parties. Organizations that operate the Exchange 20 now have the opportunity to further enhance their relationship with their existing and prospective customers and create an exciting new revenue stream. Affiliate web sites now have an online franchise which enables them to better serve existing customers, attract new customers, improve site traffic and improve online revenues without the need for a substantial investment in technology and programming.

The inventor has also developed a unique solution for large media, corporate and government archives that are currently addressing the need to digitize their video, audio and photo content to preserve it and provide easier, more cost-effective access.

The inventive system makes it possible to generate revenues to offset the cost of the digital conversion of archival content (video, audio, photos and text). This is accomplished simply by loading the content index as metadata into a secondary Exchange platform. Users are then able to search and browse the descriptions of non-digitized archival material along with existing digital content. If they see a non-digitized item of interest they may order its conversion and preview automatically from the web site at rates listed by the content provider. The order is sent to the content provider via e-mail and will be converted within forty-eight hours, or as specified by the content provider. Once converted, the content is uploaded into the inventive system and available for preview and purchase as usual. The party ordering the conversion is notified via email of the content's availability on the host site and given its item number for quick retrieval.

The cost of the conversion to the end user is equivalent to the current standard fees for dub and ship previews, and will generally be available much faster. Once previewed, the user then has the option to license the content as usual through the MEI system.

The archive now benefits by having users pay for the digital conversion of its content for the initial preview and purchase. Once converted, the content will be accessible faster and more cost-effectively to significantly more users. Large archives that would pay substantial (e.g., millions of) dollars to digitize their content up front now have a way to start the conversion process while generating revenue to offset the cost. Using the inventor's ArchiveExpress, the most requested content is digitized first and then made available for subsequent requests, eliminating the manual duplication of effort.

The invention also contemplates that participating archives begin the process by digitizing those items that historically have been in demand on a regular basis. This will give users immediate access to the most requested items in an archive and assist in generating immediate revenues.

The conversion fees are established by each content provider based on the type of content: video, audio, photos or text. The host receives a percentage of each conversion request.

With this invention, content is licensed on both a cash and barter basis through three services:

The Media Store

ArchivExpress

ConnectCast

The Media Store is the first Internet-based clearinghouse for the purchase and sale of digital content from a wide variety of content providers. This invention envisions a system to provide these services on a cash basis through its own host web site or indirectly through the client's web site via a connection designed and managed via this invention. Users can locate, preview and buy video, audio, photo and text products quickly and securely on the web site, with the system described herein providing an earned commission on each sale. All that is required is a suitable computer and an Internet connection. After previewing and selecting products, one can view prices and make purchase decisions by providing e-mail address and password to establish you as a “member”.

The Media Store offers significant economic advantages to both buyers and sellers of digital content by opening up new markets and spreading the cost of marketing and distribution across a broad user base. The universe of buyers and sellers may include, for example local radio and television stations, network news organizations, cable channels, amateur/independent users, newspapers, educational institutions, entertainment companies, corporate intranets, creative departments, advertising agencies, publishers, webmasters, governments, professional organizations, among others.

Pricing for content in the Media Store is determined by the seller. Pricing is based on the type of content (video, audio, photo or text) and intended usage by organizations and consumers. Distribution and handling costs are added to the purchase price and are paid by the buyer. These costs vary depending on the type of product and method of delivery chosen by the buyer.

Products purchased at the Media Store are delivered via the Internet, digital satellite networks, or alternatively ground carrier. Photos are delivered via the Internet; the purchaser specifies the method of delivery and video products during the purchase process.

ArchiveExpress is a unique extension of the Media Store. It allows organizations with valuable archives the ability to (1) offer on-line access to video, audio, and photo content in their archives that has not yet been digitized, and (2) charge a “conversion” fee to offset the cost of digital conversion of content when items are requested for preview. The user benefits as well by gaining on-line access to the new material, and paying a fee equivalent to the standard fees for dub and ship previews.

Large archives that need to digitize their content in order to protect the content, and to provide better access, now have a way to generate revenue during the conversion process to help offset the cost. Once converted, the content will be even more accessible to significantly more users through the Media Store. The system described herein charges each archive a fee (e.g., monthly fee) to participate in the service, and a percentage of the revenue generated from conversion requests.

ConnectCast is a syndicated multimedia showcase for an online web site. The service initially targets web sites operated by radio and television stations, newspapers, associations, government and corporations, as well as entertainment and education oriented web sites. Since ConnectCast delivers video and audio programming and e-commerce capability from the host site through a simple “plug-in”, it eliminates the hassle and expense normally required to set up such a site, while still maintaining and building strong online brand recognition for the site owner. The host intends to provide the technology, bandwidth and rich video and audio content from leading producers to keep the site entertaining and highly functional for its site hosts and their users.

ConnectCast users can view music videos, movies, news, educational material, live concerts and other exclusive programs. In addition, the ConnectCast site includes a retail outlet where visitors can browse and purchase merchandise. Media Exchange provides this service on a barter basis, earning revenues from the sale of advertising and a percentage of all sales of merchandise sold through the site.

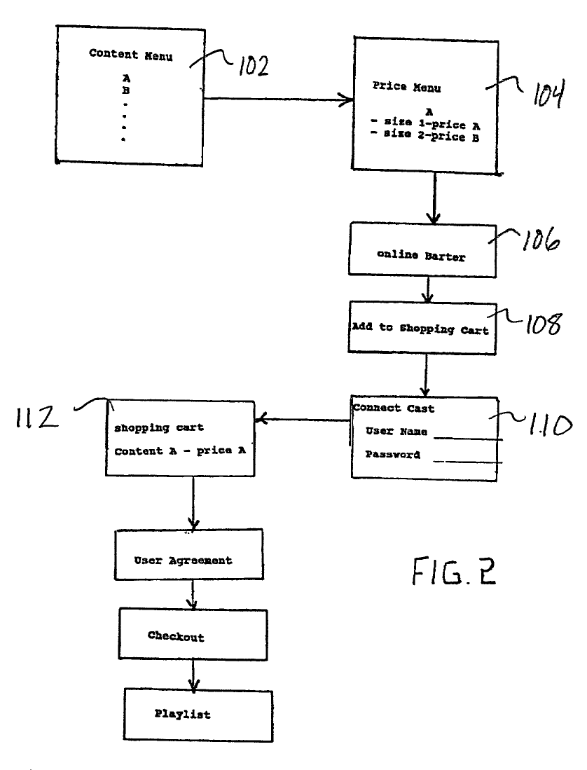

The Media Store and ConnectCast systems may interface for content ingestion. Branded ConnectCast systems will be offered to users along with a password, which will enable them to add content to the platform's playlist automatically through the Media Store. This process is shown in FIG. 2 in which an operator views a content menu at step 102. For cash purchases, the operator views a price menu at step 104 and establishes a purchase agreement with the system. Once the agreement is reached, the item may be added to a shopping cart at step 108. The user enters a user name and password at step 110 and, if approved, the items are moved to the ConnectCast shopping cart at step 112. For barter purchases, steps 104 and 108 not necessary, and selected items are added directly to shopping cart at step 112 when the user enters a valid user name and password at step 110.

The operation of the system described by this invention will now be described. Users will go to the host's Media Store web site at and locate the content they wish to add to their ConnectCast site. They will select either a price from the pull-down window, or they will select the online barter option. They will then press the “Add to Shopping Cart” button. A window will come up requesting their ConnectCast “user name” and “password”. They will fill this in and the item will be added to the shopping cart. Once they have finished adding items, they will go to checkout. If all of the items in the shopping cart are barter items, they will approve the user agreement and then they will go to a barter checkout page, confirming their user information. For cash item, they will process their payment option and then go to the cash check-out page. They will press checkout and the items will automatically be added to the playlist on their ConnectCast system.

The ConnectCast system includes the custom design, ongoing support and development, and bandwidth.

Content providers will receive compensation for the use of their content on these ConnectCast systems. For barter sales, they will receive payment in direct proportion to the amount of advertising sold while their content was viewed. The host will develop a tracking device (CC Tracker) that will report on a specified basis the number of advertising impressions associated with the viewing of each content item. Revenue will then be paid to the content provider for cash sales or advertising revenue on a period basis.

This capability ties the ConnectCast system to the Media Store for content. The two systems can be offered to networks on a branded basis. Under this scenario a network will have a branded Media Store offering only its content. Affiliates of the network can be provided branded or co-branded (featuring the network logo) ConnectCast systems. The network affiliates will go to the network Media Store site to select content to go on their network ConnectCast system.

In accordance with this invention, the host receives a monthly fee for licensing the proprietary system and a percentage of the advertising revenue from the ConnectCast sites.

While this invention has been shown and described with reference to specific examples and drawings, it will be understood that various changes in form and detail may be made therein without departing from the spirit and scope of the invention.

What is claimed is:

1. A method for use on the Internet in which a user's web site provides a list of digital content items, comprising video, audio, photos and text contents, said method comprising the steps of:
communicating with the exchange web site;
selecting at least one digital content item from a list of digital content items to thereby define a selected item;
adding the selected item to a stand-alone web player;
providing a link on the user's web site to the selected item added to the stand-alone web player;
automatically enabling the selected item to be accessed from said stand-alone web player via the link on the user's web site.

2. The method of claim 1, further comprising the step of purchasing the selected item selected in the selecting step.

3. The method of claim 1, further comprising the step of identifying the user to the exchange web site to enhance security.

4. The method of claim 1, wherein said step of identifying includes a step of inputting a user name and password.

5. The method of claim 1, further comprising the step of agreeing to a set of purchase terms provided by the exchange web site.

6. The method of claim 1, further comprising the step of originating said digital content items from a plurality of content suppliers.
